(19) United States
(12) Patent Application Publication
(10) Pub. No.: US 2026/0188290 A1
(43) Pub. Date: Jul. 2, 2026

(54) DYNAMIC LOAD-BASED NOISE CANCELATION

(71) Applicant: Nvidia Corporation, Santa Clara, CA (US)

(72) Inventors: Mihir Manohar Nyayate, Pune (IN); Elad Mentovich, Tel Aviv (IL); Siddha Ganju, San Jose, CA (US); Ryan Albright, Beaverton, OR (US); John Franz, Tomball, TX (US)

(21) Appl. No.: 19/002,211

(22) Filed: Dec. 26, 2024

(51) Int. Cl. G10K 11/178

(52) U.S. Cl. CPC G10K 11/178

(57) ABSTRACT

Approaches presented herein provide for active noise cancelation for individual components in an environment such as a data center. There can be various heat-generating components in a data center, as may include servers, processors, and network switches, that also result in the generation of excess noise, such as may be produced by fans used to remove heat from these components. An exhaust tubing can be used to direct a flow of heated air, directed by a fan, from an opening in a sound-proof housing to an outlet of the tubing. A microphone can be placed inside the exhaust tubing to record the waveform of the noise emitted by the fan that is directed into the exhaust tubing. An inverted phase waveform can be generated and provided for playback by a speaker in the exhaust tubing. The inverted phase waveform will combine with the emitted waveform and, through destructive interference, largely cancel out the emitted waveform. If the workflow corresponds to a predictable load, the noise cancelation functionality can be activated and deactivated based on anticipated need, and aspects of the playback can be adjusted to provide for maximum noise cancelation.

### TECHNICAL FIELD

This disclosure relates to the management of noise in a resource environment, and in at least one embodiment relates to the reduction in noise generated by fans, pumps, and/or other electronic components in a data center.

### BACKGROUND

As an increasing amount of data and instruction processing is performed using shared resources, or “cloud” resources, there is a need to provide increased processing capacity (as well as increased storage and networking capacity, etc.). Accordingly, environments such as data centers are increasingly becoming tightly packed with high-performance resources. A large number of high-performance resources in a relatively compact setting can generate a significant amount of heat, which can be removed through a combination of air and liquid cooling in many instances. As an example, a data center used for inferencing using large artificial intelligence (AI) models might include several racks of graphics processing units (GPUs) stacked against one another. In order to cool these GPUs, there may be multiple fans used to direct heated air away from the GPUs. The large number of powerful fans can create a lot of fan noise - to the extent that it may become extremely difficult and/or uncomfortable for engineers to work in such a data center or server room due to the excessive noise.

### BRIEF DESCRIPTION OF THE DRAWINGS

Various embodiments in accordance with the present disclosure will be described with reference to the drawings, in which:

FIG. 1A illustrates an example system architecture in which aspects of various embodiments can be implemented, according to at least one embodiment.

FIG. 1B illustrates an approach to cooling heat-generating components in a data center, according to at least one embodiment.

FIGS. 2A and 2B illustrate example designs of an active noise cancelation device, according to at least one embodiment;

FIGS. 3A, 3B, and 3C illustrate destructive interference of waveforms with inverted phases, according to at least one embodiment.

FIG. 4 illustrates an example process that can be performed to provide active noise cancelation of a specific noise-generating component, according to at least one embodiment.

FIG. 5 illustrates an example data center system, according to at least one embodiment;

FIG. 6 is a block diagram illustrating a computer system, according to at least one embodiment;

FIG. 7 is a block diagram illustrating a computer system, according to at least one embodiment;

FIG. 8 illustrates a computer system, according to at least one embodiment;

FIG. 9 illustrates a computer system, according to at least one embodiment;

FIG. 10 illustrates exemplary integrated circuits and associated graphics processors, according to at least one embodiment;

FIGS. 11A, 11B illustrate exemplary integrated circuits and associated graphics processors, according to at least one embodiment;

FIG. 12 illustrates a computer system, according to at least one embodiment;

FIG. 13A illustrates a parallel processor, according to at least one embodiment;

FIG. 13B illustrates a partition unit, according to at least one embodiment; and

FIG. 14 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), systems for performing generative AI operations (e.g., using one or more language models), systems for performing light transport simulation, systems for performing collaborative content creation for 3D assets, systems implemented at least partially using cloud computing resources, and/or other types of systems.

Approaches in accordance with various illustrative embodiments can provide for the reduction of noise in an environment containing many noise-generating electronic components. This can include, for example, a data center including a large number of servers and processing units. In particular, various embodiments of this disclosure provide for the reduction and/or cancelation of noise (or other sound) generated by, or associated with, individual GPUs, network switches, or other such components, as well as the components (e.g., fans or pumps) used to cool or operate those heat-generating components. Each rack in a data center may contain multiple GPUs stacked against one another, for example, which can lead to excessive noise - to the extent that it can be difficult for engineers to even work in the room. In order to reduce or cancel out much of this noise, active noise cancelation can be used for individual fans and GPUs. A GPU may be positioned in an interior of a sound-proof casing, which is primarily enclosed other than having an opening to allow for the expulsion of hot air. During operation, the GPU may generate a significant amount of heat which may be directed away from the GPU, through the opening, in order to remove at least a portion of the excess heat. A pipe, tube, enclosure, or other directional outlet can be positioned at the opening to direct the heated air in a particular direction, such as toward the back of a rack and away from other active components. A microphone may be positioned in (or proximate) the outlet pipe, near the opening, to capture the sound of the fan (and any other noise generated by the GPU or captured by the microphone). A circuit/chip in the outlet pipe (or otherwise connected to the microphone) can analyze the audio data captured by the microphone and generate inverse audio data that corresponds to an inverted waveform of the captured audio with similar amplitude (representing a 180-degree change in phase). The inverse audio can then be played back by the speaker, which can reduce the volume of, or effectively cancel out, the generated audio/noise if performed at the appropriate volume and timing. Positioning the microphone near the inlet of the pipe and the speaker near the outlet of the pipe can help to ensure appropriate timing due to the time needed to generate the inverse audio. In order to avoid the microphone having to actively listen all the time, which can take a significant amount of power for a large number of GPUs, information about the anticipated load or known load on a given GPU can be used to determine when to activate/deactivate the microphone and inverse audio system. For example, it may be known that a specific type of GPU starts to produce heat that requires fan noise removal at a certain load, and the microphone and inverse audio system can be activated when such a load is expected, as may be known for precisely definable workloads, such as those used when training or performing inferencing using AI. Such approaches can be used for heat- and noise-generating devices other than GPUs and fans as well, such as network switches or other types of processing units. The noise or audio able to be canceled includes not only fan noise, but also audio produced through the singing of one or more inductors or capacitors, or the humming of one or more liquid pumps, among other such options.

Variations of this and other such functionality can be used as well within the scope of the various embodiments as would be apparent to one of ordinary skill in the art in light of the teachings and suggestions contained herein.

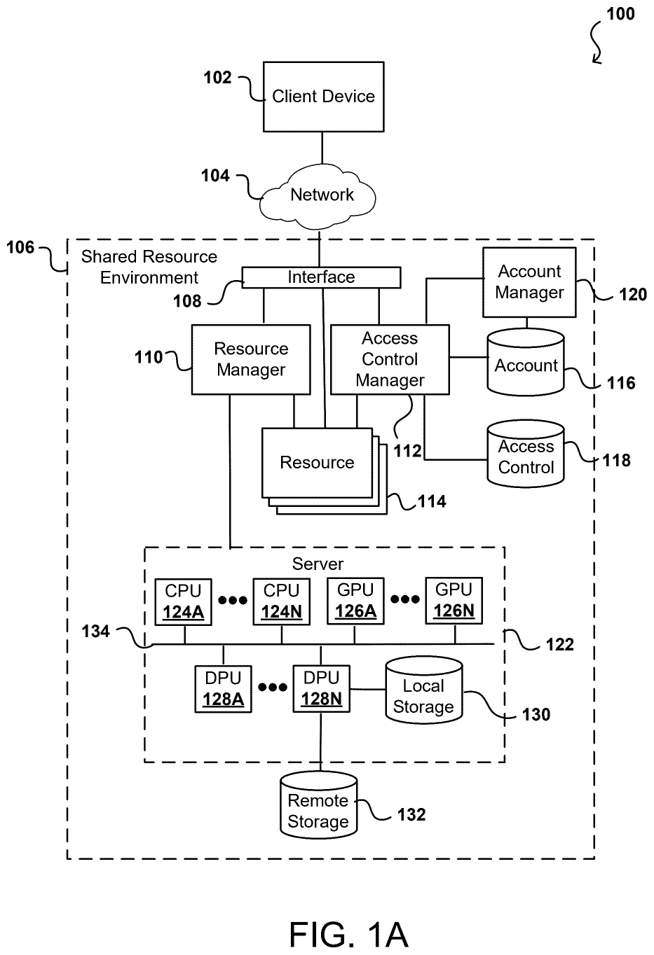

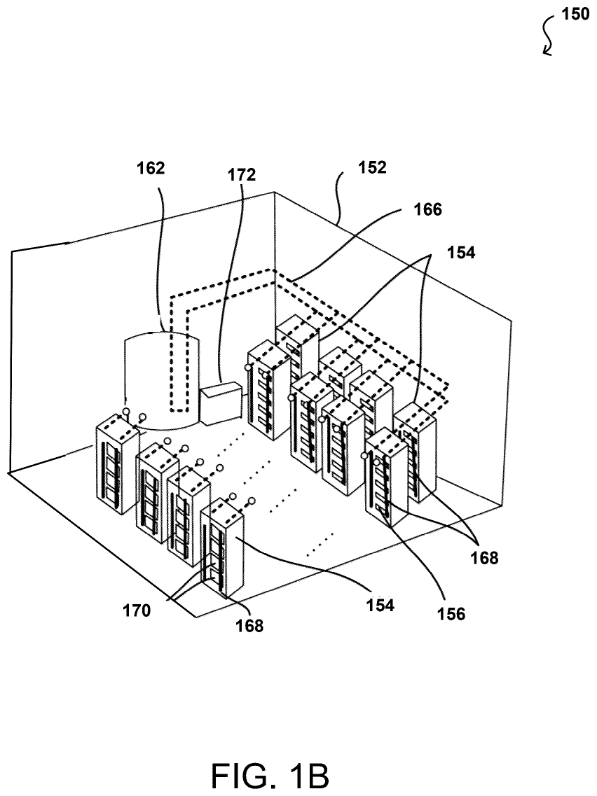

Environments such as data centers can be used to perform various computing operations on behalf of a number of different entities, such as by using a pool of available resource capacity. FIG. 1A illustrates an example of one such architecture 100 that can be used in accordance with at least one embodiment. In this example, a user is able to use a client device 102 to submit one or more requests to access one or more resources, or to perform a task using one or more resources, among other such options. Such a request can be submitted over at least one network 104, such as the Internet or a cellular network, and received to an interface, address, or endpoint in a shared resource environment 106. The request can be received to an interface, such as an application programming interface (API) of an interface layer 108, for example, which may include other networking devices as well, as may include routers, network switches (e.g., an NV-Switch or Spectrum-X switch), load balancers, and the like. In this example, a request from a client device 102 may first need to be analyzed to determine whether the client device, user, or other entity associated with the request has access to one or more resources to be used to process the request, as well as to determine whether the type of access permitted allows for performance of the requested operation.

In this example, information for the request can be directed to an access control manager 112, or other such component, system, or service. The access control manager 112 can perform various tasks to determine and/or manage access to a set of shared resources, such as to extract relevant information from a received request and compare, by an account manager 120 or other such system or service, information for the request against information in an account repository 116 or other such location. This operation can be used to determine whether the request is associated with a valid account associated with the shared resource environment, such as an account maintained by a user with a provider of the shared resource environment 106. Once determined, that account information can be used to determine the type of access permissible to perform one or more operations associated with the request. This may include, for example, determining (or verifying) an authorized user identifier associated with the request, then using that user identifier to determine access permissions associated with that user identifier, as may be stored in an access control data repository 118 or other such location. In at least one embodiment, an access control manager 112 may include various modules to perform specific tasks, such as an authorization module and an authentication module, or may run on a network server that also has these modules available for use with the access control manager 112, among other such options.

Once a set of access permissions is identified that is associated with the request, the access control manager 112 (or an associated process) can determine whether the necessary permissions exist in the set to process the request which was received from the client device and associated with the user identifier. If the appropriate permissions are determined to exist or be available, the access control manager 112 can direct information for the request to one or more shared resources 114 (and/or potentially dedicated resources) in the shared resource environment 106. In some embodiments, the access control manager 112 may work with a resource manager 110 to determine a specific instance of a type of resource to be used to perform an operation with respect to the request, whereas the resource manager 110 can perform other types of operations as needed, such as to allocate additional capacity of a type of resource, launch a new compute instance, or perform another such task associated with the request.

In many instances, a request that involves a number of operations to be performed may have those operations, or portions of those operations, distributed across a set of processing resources. This may include distribution across a number of physical compute resources, such as a set of shared servers, and/or may include multiple processing resources (physical or virtual) within a given physical resource. As an example, FIG. 1A illustrates example components that may be found within a given server 122 that may be allocated to perform one or more processing tasks with respect to a request. The server 122, in this instance, is illustrated to contain different types of processing units, including one or more central processing units (CPUs) 124A-N, one or more graphics processing units (GPUs) 126A-N, and one or more data processing units 128A-N, as may be interconnected using at least one internal bus 134. At least the DPUs 128A-N in this example may be connected to local storage 130 in the server, as well as at least one remote storage instance 132 that may be external to the server but within the shared resource environment 106. CPUs 124A-N are often used for tasks such as single threaded user applications, and GPUs 126A-N are often used to perform multiple small but related operations in parallel. DPUs can be used to offload processing tasks from these CPUs and GPUs that may not optimally be performed on these processing units, as may related to heterogeneous data-centric processing tasks that can benefit from a different type of accelerated processing. A DPU is a programmable processor or system-on-chip, which combines one or more multi-core, high-performance CPUs, a set of acceleration engines that can offload and improve performance for data-centric tasks, and one or more high-performance interfaces capable of parsing, processing, and efficiently transferring data at high speeds. A DPU can be used as a stand-alone embedded processor, or can be incorporated into a smart network interface card (SmartNIC) in a server, among other such options. Offloading of appropriate tasks to such DPUs can help to enhance performance and reduce power consumption, among other such benefits. Processing units such as DPUs can be particularly useful for data-centric tasks such as those relating to artificial intelligence and machine learning. This can include the performance of various matrix multiplication tasks, among other such operations. In at least some embodiments, the workload on various GPUs 126 and DPUs 128 may be well understood, such that the load on these components can be predicted with relative accuracy for future points in time, which can be beneficial for various embodiments as discussed in more detail elsewhere herein. This prediction can come from the resource manager 110 or an application manager (not shown), among other such options.

In at least one embodiment, a data center may utilize both liquid and air cooling, among other such options. For example, a data center 150 as illustrated in FIG. 1B can include one or more rooms 152 having racks 154 and auxiliary equipment to house one or more servers 170 on one or more server trays, as well as graphics processing units (GPUs) 156 and other such components. In at least one embodiment, a data center 150 is supported by a cooling tower located external to the data center 150. A cooling tower can dissipate heat from within a data center 150 by acting on a primary cooling loop 166. In at least one embodiment, a cooling distribution unit (CDU) 162 is used between a primary cooling loop 166 and a secondary cooling loop, or other such heat removal mechanism. In at least one embodiment, a secondary cooling loop can access various plumbing into a server tray as required. In at least one embodiment, flexible polyvinyl chloride (PVC) pipes may be used along with associated plumbing to move fluid along in each provided cooling loop 166. One or more coolant pumps may be used to maintain pressure differences within the cooling loops 166 to enable movement of coolant according to temperature sensors in various locations, including in a room 152, in one or more racks 154, and/or in server boxes or server trays within one or more racks 154. A bio cleaner 172 may be used to clean the coolant in the cooling loop, such as to prevent the growth of bacteria or other such biological agents.

In at least one embodiment, coolant in at least a primary cooling loop 166 may comprise at least water and an additive. Such an additive may be, for example, and without limitation, glycol or propylene glycol. In operation, different cooling loops may have their own respective coolants. In at least one embodiment, a CDU 162 is capable of sophisticated control of coolants, independently or concurrently, within provided cooling loops. In at least one embodiment, a CDU may be adapted to control flow rate of coolant so that coolant is appropriately distributed to absorbed heat generated within associated racks 154. Flexible tubing of a row manifold 168 can be from a cooling loop to enter each server tray to provide coolant to electrical and/or computing components therein. Tubing of a row manifold that forms part of a cooling loop may be referred to as a room manifold. In at least one embodiment, row manifolds can extend to all racks along a row in a data center 150.

In operation, heat generated within server trays of provided racks 154 may be transferred to a coolant exiting one or more racks 154 via flexible tubing of a row manifold 168 of a cooling loop 166. Spent or returned second coolant (or exiting second coolant carrying heat from computing components) exits out of another side of a server tray (such as enter left side of a rack and exit right side of a rack for a server tray after looping through a server tray or through components on a server tray). In at least one embodiment, spent second coolant that exits a server tray or a rack 154 comes out of different side (such as exiting side) of tubing of a row manifold 168 and moves to a parallel, but also exiting side of a row manifold. In at least one embodiment, spent second coolant exchanges its heat with a primary coolant in a primary cooling loop 166 via a CDU 162. In at least one embodiment, spent second coolant may be renewed (such as relatively cooled when compared to a temperature at a spent second coolant stage) and ready to be cycled back to through a cooling loop to one or more computing components. In at least one embodiment, various flow and temperature control features in a CDU 162 enable control of heat exchanged from spent second coolant or flow of second coolant in and out of a CDU 162. In at least one embodiment, a CDU 162 may be also able to control a flow of primary coolant in primary cooling loop 166.

In addition to liquid cooling, there can be at least some amount of air cooling performed for various components. For example, there may be aisles between rows of racks that alternate between hot aisles and cold aisles, where heated air is directed into the hot aisles (typically being extracted through vents in the ceiling) and cool air directed from the cold aisles (such as from inlets in a raised floor) into the racks of electronic components, to provide for a flow of cool air and removal of heated air. The heated air can then be directed to a heat exchanger or exhausted to an exterior of the building, among other such options). To assist with air flow, there may be one or more electronic fans (as well as heat sinks and other such components) to direct an appropriate flow of air to assist with heat removal. In at least one embodiment, devices or components such as servers and GPUs can have one or more fans that direct heated air away from the electronics, typically out of a housing or enclosure surrounding the electronics. In many instances, the heated air will be directed to a hot aisle or other location from which the heat can be removed, such as by using a liquid cooling loop, floor or ceiling vents, and the like.

As mentioned, however, each fan can produce a certain amount of noise, which may depend in part upon the speed of the fan (for variable speed fans). The speed may be increased when the temperature of a component, or near a component, exceeds a particular temperature threshold, as may be associated with a higher load on a given component. For periods of high load, there may be a number of fans all running at high speed at the same time, which can result in an excessive amount of noise in the data center or server room. There may be other sources of noise as well that add to the overall volume. This noise can be uncomfortable for technicians, engineers, or others who need to work in that room or area.

Approaches in accordance with various embodiments can attempt to offset or minimize the amount of noise generated by electronic components, such as cooling fans, in a resource environment such as a data center or server farm. At least some of these approaches can also adjust the noise reduction dynamically in response to current conditions, and in at least some embodiments can anticipate cooling needs for upcoming, well understood loads, such as anticipated loads for large, long-running artificial intelligence (AI) training or inferencing jobs.

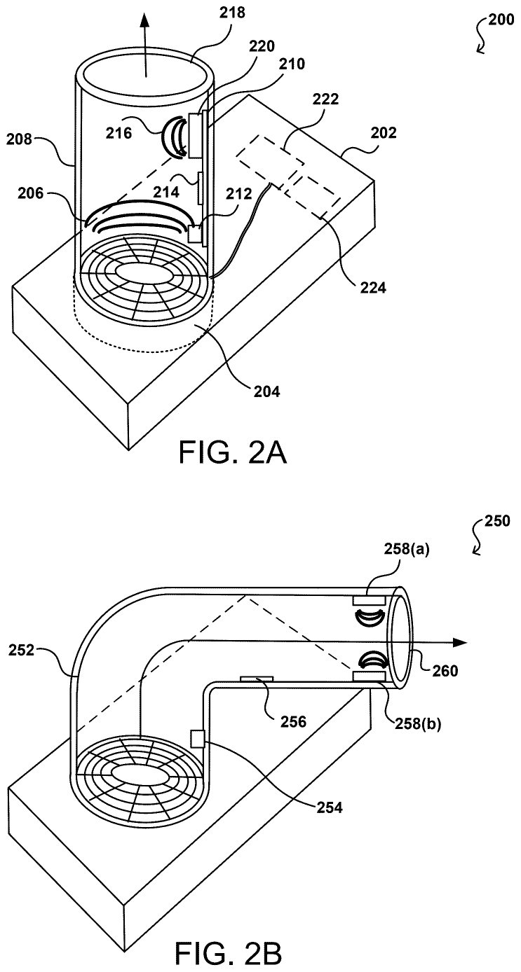

In at least one embodiment, active noise cancelation can be used to attempt to suppress at least a significant portion of this or other such noise. This can include, for example, performing active noise cancelation for individual sources of noise in a data center. FIG. 2A illustrates a first example noise cancelation assembly 200 (or noise canceling casing, etc.) that can be used in accordance with at least one embodiment. This example noise cancelation assembly 200 can include a noise cancelation device 208 through which noise from a fan 204, or other noise-producing component, can be directed. In this example, the fan 204 is included in a sound-proof housing 202 which can be used to house one or more heat-generating components 224, such as a graphics processing unit (GPU). An opening in the housing allows for heated air, directed away from the heat-generating component(s) 224 by the fan 204, to be directed to an exterior of the housing, allowing for removal of at least some of the heat generated by the heat-generating component(s) 224. In this example, the heated air can be directed through the noise cancelation device 208 and out an opening or outlet 218 at the opposite end (or a selected location) of the noise cancelation device 208. A shape and size of the noise cancelation device 208 can determine the amount and direction of flow of heated air directed out of the sound-proof housing 202 by the fan 204. For larger housings, there may be one or more fans (or other heat-removal apparatus). The sound-proof housing 202 and noise cancelation device 208 can both be formed of the same, or a different, sound-proof or sound insulating material, as may include a plastic or polymer with embedded synthetic fibers, such as polyester fibers that are lightweight, non-toxic, and moisture resistant. Such a material also has a high tensile strength and is resistant to fire and abrasion, while being relatively inexpensive relative to other potential materials.

As mentioned, a heat-removal device such as a fan 204 can create a substantial amount of noise. If the fan is positioned within a sound-proof housing 202, such as a GPU housing formed of a material that prevents most transmission of sound, then the sound produced by the fan that is not absorbed within the sound-proof housing 202 will be directed through the fan opening in the housing. In this example, the noise cancelation assembly 200 has an outer casing (e.g., tubing) made from a sound-blocking or sound-proof material, such that the sound 206 from the fan that is transmitted through the fan opening will be directed through the noise cancelation device 208 and out the outlet 218 at an end of the casing. It should be understood that the noise cancelation device 208 can be a separate device that is connected to the sound-proof housing 202 proximate to the opening for the fan 204, while in other embodiments the noise cancelation device 208 can be part of the sound-proof housing, as may be formed from the same material as a housing with built-in noise cancelation, among other such options. In some embodiments, the housing and/or enclosure may not be formed from a noise-blocking material, but may have an interior lining of a sound insulating material, among other such options.

In the example noise cancelation assembly 200 of FIG. 2A, the sound 206 from the fan 204 that is not absorbed inside the sound-proof housing 202 will be primarily directed through a noise cancelation device 208 and out the outlet 218. In order to reduce the amount of this noise that is emitted from the outlet 218, the noise cancelation device can include components that are able to perform active noise cancelation. Active noise cancelation in this case involves determining the waveform of the sound 206 emitted by the fan. In this example, this can be performed using a microphone 212 positioned close to the end of the noise cancelation device 208 that is proximate the opening for the fan 204. The microphone 212 can then record the sound, which can be passed to a local processor 214, such as an embedded microprocessor of a system on chip (SoC) 210 including the microphone 212, to analysis, in order to determine the waveform for the sound 206. The local processor 214 can then generate an inverted sound wave that has the same amplitude as the emitted sound wave, but with an inverted phase relative to the emitted sound wave. This inverted sound wave 216 can then be provided for playback by at least one speaker 220 positioned in the noise cancelation device. The at least one noise cancelation speaker 220 may also be connected to, or part of, the system on chip 210. In this example, the speaker is positioned closer to the outlet 218 than the microphone, which can be beneficial as the time it takes the emitted sound wave to pass from the microphone to the speaker can help to offset the small latency needed to generate and playback the inverted sound wave 216. In at least some embodiments, the inverted sound wave can have a slight offset applied in time to attempt to account for the difference in transmission speed and wave generation latency. When the inverted sound wave 216 is played in the noise cancelation device 208, the inverted sound wave 216 will combine with the emitted sound 216 to form a new wave through destructive interference, where the opposite waveforms will effectively cancel each other out. Since this destructive interference will occur within the tubing of the noise cancelation device 208, the emitted sound 206 will be canceled out before passing through the outlet 218, thus preventing a majority of the noise from the fan 204 from making it outside the sound-proof housing 202 and noise cancelation device 208.

Active noise cancelation can be achieved through use of digital signal processing (DSP) or an analog circuit, among other such options. An adaptive approach can continually analyze the waveform of aural and/or non-aural noise, and can generate a signal or waveform that has an appropriately-shifted phase or inverted polarity with respect to the monitored signal or waveform. In at least one embodiment, the inverted waveform can be amplified and a transducer can create a sound wave that is proportional to the amplitude of the emitted waveform to create destructive interference. The amplitude can be adjusted to control the amount of noise reduction, or volume of the remaining nose, such as where it may be desirable to let a small amount of fan noise emit from the noise cancelation device 208 so that a technician near the housing can determine that the fan is running through the emitted and non-canceled sound. The noise cancelation speaker 220 in this example may be co-located with the source of sound that is to be reduced or attenuated. Such speakers can be placed at other locations as well, such as in headphones worn by technicians or on the walls of a data center, where the speaker may playback an inverted waveform that is based on an aggregate of all waveforms determined for the data center, although such an approach may provide for less accurate noise cancelation as the volume for any given noise source will vary based on distance, and an accurate noise canceling wave form would need to take this into account, such as where a speaker array is used and each speaker may play back a slightly different inverted waveform based on the determined volumes of each of the sources near the speaker locations. Noise cancelation approaches that are away from individual sources may experience challenges in some instances, as the three-dimensional wavefronts of the emitted noise and the cancelation noise may create alternating zones of constructive and destructive interference, which may result in a noise reduction in some regions but may actually result in a noise amplification in other regions. Placing at least one microphone and speaker inside a noise cancelation device 208 as illustrated in FIG. 2A can help to move noise coming from a fan placed proximate a GPU, while also ensuring that appropriate cooling is provided at the same time. The example of FIG. 2A illustrates a noise canceling device per fan and GPU, but it should be understood that there may be multiple fans or GPUs per noise cancelation device, or multiple noise cancelation device per fan and GPU (or other heat-generating and/or sound generating component(s)), among other such combinations and configurations. As illustrated, the power for the system on chip 210 and related components can be provided from a power source 222 in the GPU housing, among other such options. In at least one embodiment, an embedded processor 214 of the system on chip 210 can communicate with the GPU or other heat-generating component(s) 224.

As mentioned, devices such as servers and GPUs may be placed in a rack, spaced relatively closely and in a similar orientation. Accordingly, it may be beneficial for at least some of these configurations to select a design for the noise cancelation device that makes best use of the available space. For example, in the design 250 illustrated in FIG. 2B the casing 252 of a noise cancelation device may be shaped to direct the flow of heated air to a particular direction or location. For example, a noise cancelation device may be shaped to receive air from an opening for a fan in the top of a sound-proof housing. This may include having a bend in the casing 252 that allows heated air, directed upward from the fan, to be redirected to pass out an open back of the rack, and away from other GPUs or heat-sensitive devices. In this example, the casing 252 is a tube that is primarily circular in cross-section, and that has a bend after approximately 2 inches to help save space above and below the GPU in the rack, as well as to direct the heated air toward and out the back of the rack, such as into a hot aisle. Dimensions of the noise cancelation device can vary based upon factors such as the size of the GPU or housing, as well as the location of the fan opening and space between devices in a rack, among other such factors. In this example, a microphone 254 can be placed in the noise cancelation device before the bend (or between the fan and the bend), with the speaker 258 being placed near the outlet 260. As illustrated, there may be more than one speaker 258(a)-(b) or a speaker array, or a circular speaker that wraps around an interior of the casing near the outlet 260, among other such options. A processing unit 256 for generating the inverse waveform to be played by the speaker(s) 258(a)-(b) may be in or on the exterior of the casing 252, may be located in the sound-proof housing, or may be positioned on a remote component, among other such options, although having the processing unit close to the microphone and speaker can help reduce latency and improve the quality of the noise cancelation.

As mentioned, a benefit to running well understood or anticipated workloads in a data center or other such location is that the future load one or more heat-generating components can be well predicted. This information can be used advantageously to know when to activate noise cancelation, as well as how to dynamically adjust aspects of the noise cancelation over time to achieve the best possible noise cancelation results. For example, various AI-related jobs, such as performing a type of inferencing or training, are generally well-understood and predictable. Such jobs or workflows can be simulated, with the load then used to control the noise cancelation as appropriate. In other embodiments, a machine learning model can be trained on various types of jobs or workflows, and can infer the load on any given component to be used for the workload at any time. This allows for accurate predictions of aspects of operation such as power delivery, thermal variations, and noise generation.

One advantage to having such knowledge is that this knowledge can be used to determine when to activate a given noise cancelation device. For example, it can be determined that a fan for a given GPU will activate at a given time, or within a predictable period of time. Instead of keeping the noise cancelation active, such that the microphone needs to be powered on continually and the signal analyzed, the noise cancelation functionality can be activated around the time that the fan is to be activated, or when the fan is to accelerate to above a threshold speed which will produce more than an threshold amount of noise. The noise cancelation functionality can also be deactivated when the fan drops below that threshold speed and is not anticipated to again exceed that threshold speed for at least a determinable future period of time. Such an approach can help to reduce power consumption, as components such as the microphone, speaker, and embedded processor only need to be active during periods of relatively high load. For unpredictable or varying loads, the increase in load can be determined by a resource monitor, for example, and then this information is used to activate noise cancelation functionality. Such an approach can also reduce the load on the embedded processor (or circuitry, etc.), which instead of continually analyzing an input waveform even during times of silence or inactivity, the processor can only (or primarily) analyze the waveform during, or near, appropriate periods of activity requiring, or benefitting from, such active noise cancelation.

The ability to communicate with the GPU and also obtain or determine information about the future load can also help the noise cancelation to be more proactive, instead of reactive as in many prior systems. The embedded processor can determine that the load on the chip is going to increase or decrease in the near future, and can make adjustments as appropriate. For maximum noise cancelation, it can be desirable to start the noise cancelation as close to the actual noise increase or emission as possible, in order to avoid a period of time towards the beginning where an appreciable amount of noise is emitted while the noise cancelation process initializes and generates an appropriate inverse waveform. Further, near a time of reduction it may be desirable to reduce the volume of the inverse waveform that is played back in order to avoid inadvertent playback that generates additional noise instead of canceling existing noise. The embedded processor can use this information to adjust volume, amplitude, delay, or other such aspects, in order to attempt to dynamically optimize noise cancelation. Turning off the speakers as soon as they are no longer needed can also help to reduce excess noise.

Another advantage of such a solution is that it can be relatively low power during periods of activity. Because noise-generating components such as computer fans tend to emit noise at relatively low frequencies, often between 100 Hz and 250 Hz, a relatively inexpensive and low power microphone can be used. Similarly, a relatively low power speaker can be used to play back the inverse waveforms at these low frequencies. This low frequency “hum” is relatively easy to offset with little variation, and small inaccuracies will not result in an appreciable amount of un-canceled noise in many instances. In some embodiments, using a cheaper microphone that will not pick up higher frequency noise may be beneficial in order to cancel out a specific type of noise, such as fan noise, while not canceling out other sources of noise, such as a human speaking instructions or an alarm sounding in a data center.

In some embodiments, the sound generated by a fan for a certain load can be modeled, and this sound can be used to generate an inverse waveform to use to cancel noise, without the need to capture the actual noise using a microphone. As there will be variations (e.g., different frequency responses) between individual GPUs and fans (or other heat- and/or noise-generating components), and these variations can change or drift over time, it can produce more accurate results to capture the actual emitted waveform and generate an inverse of the actual waveform, to avoid the issuance of noise that is not canceled due to improper inverse waveform generation. Further, the same type of noise cancelation device may be used with multiple different heat-generating devices, and it may be difficult to accurately model the sound produced by these various types of devices and may actually save processing and power by using a microphone during periods of activity. For components such as CPUs where the workload is often not very predictable, a noise canceling device can be used as disclosed herein, but may not benefit from some of the predictive and proactive aspects discussed with respect to more predictable loads or workflows.

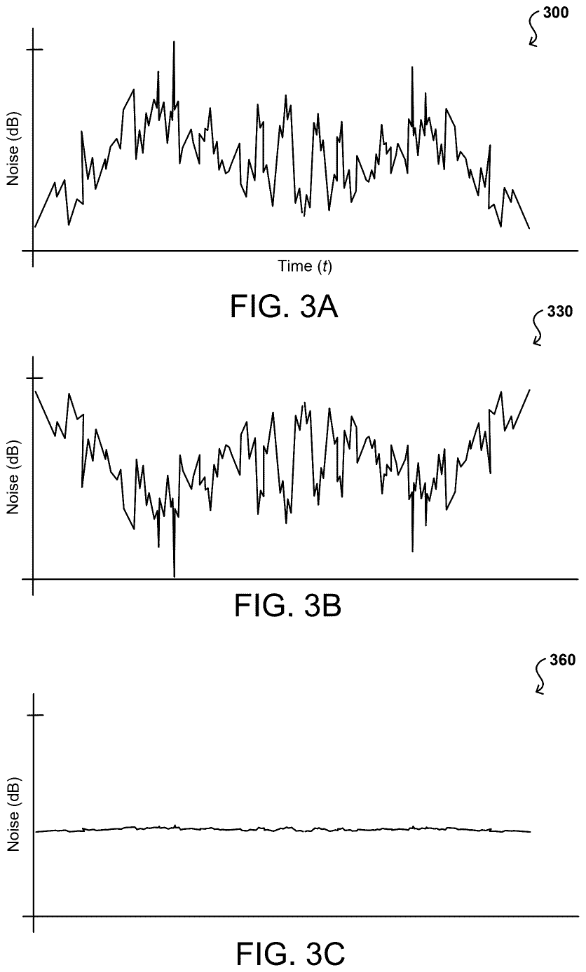

FIG. 3A illustrates a simplified example of a waveform 300 for audio or noise generated by a noise-generating component, such as a fan, according to at least one embodiment. As illustrated, there are various peaks and valleys in the waveform, and the general amplitude of the waveform at different regions can correspond in part to the speed of the fan, as may vary based in part on the load on the corresponding heat-generating component. FIG. 3B illustrates an example of an inverted waveform 330 that can be generated with respect to the emitted waveform 300. As illustrated, the phase of the inverted waveform is flipped vertically (in the figure) with a similar amplitude. If the inverted waveform 330 is played with appropriate volume along with the emitted waveform 300, the two waveforms will effectively cancel each other out through destructive interference, resulting in a significantly reduced amount of noise with little variation in amplitude, as illustrated in the example reduced waveform 360 of FIG. 3C. As illustrated, there may still be some amount of noise emitted, but the volume and variation should be substantially reduced with respect to the original emitted noise.

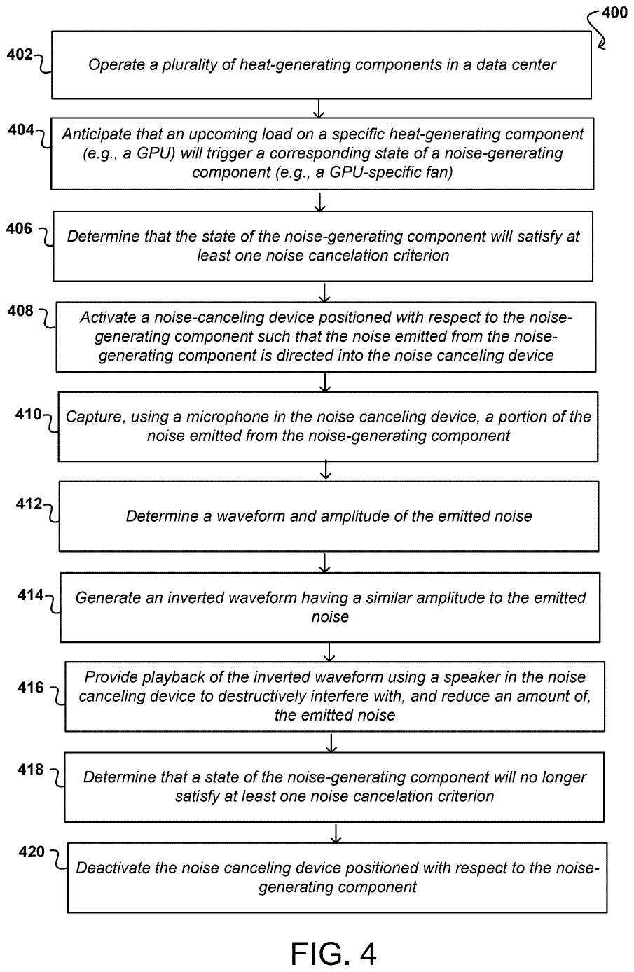

FIG. 4 illustrates an example process 400 that can be performed to cancel noise generated by a cooling fan for a GPU, in accordance with at least one embodiment. It should be understood that for this and other processes discussed herein that there may be additional, fewer, or alternative steps performed in similar or alternative orders, or at least partially in parallel, within the scope of the various embodiments. Further, although discussed with respect to a fan and a GPU, it should be understood that advantages of such a process can be obtained for other types of heat-generating and/or noise-generating components as well within the scope of various embodiments. In this example process, a plurality of heat-generating components (e.g., servers, processing units, network switches, and the like) can be operated 402 in a data center or other such location. The workflows to be processed using these components can be monitored, and it can be anticipated 404 that an upcoming load on a specific heat-generating component will trigger a corresponding state of a noise-generating component. As an example, it can be anticipated that an upcoming load on a GPU will produce a predictable amount of heat, which will cause an associated fan to operate at a corresponding speed or power level to provide for adequate heat removal. The noise generated by the fan at such speed can also be predicted with relative accuracy. It can be determined 406 that the state of the noise-generating component, such as the speed at which the fan will have to rotate, will satisfy at least one noise cancelation criterion. This can include the fact that the speed will cause the fan to make at least a detectable amount of noise in at least one embodiment, or that the fan will produce more than a threshold amount of noise at that speed, among other such options. In response, a noise canceling device can be activated 408 that is positioned with respect to the noise-generating component such that the noise (or sound) generated by the noise-generating component is directed into the noise canceling device, without an ability to slip out into the data center. A microphone in the noise canceling device can capture 410 a portion of the noise emitted from the noise-generating component. The captured noise (or audio containing the noise) can be analyzed to determine 412 a waveform and an amplitude of the emitted noise. An inverted waveform can then be generated 414 that has a similar amplitude to the emitted noise but that is inverted in phase with respect to the emitted waveform. Playback of the inverted waveform can be provided 416 using a speaker in the noise canceling device to destructively interfere with, and reduce an amount of, the emitted noise. This can occur over a period of operation, until such time as it is determined 418 that a state of the noise-generating component will no longer satisfy at least one noise cancelation criterion, such as when it is predicted the fan will stop spinning or will spin at such a slow rate that the noise produced will be minimal. The noise canceling device positioned with respect to the noise-generating component can then be deactivated 420, which can help to reduce power and resource consumption, as well as to prevent the production of additional noise in the data center that might otherwise emanate from the speaker.

### Data Center

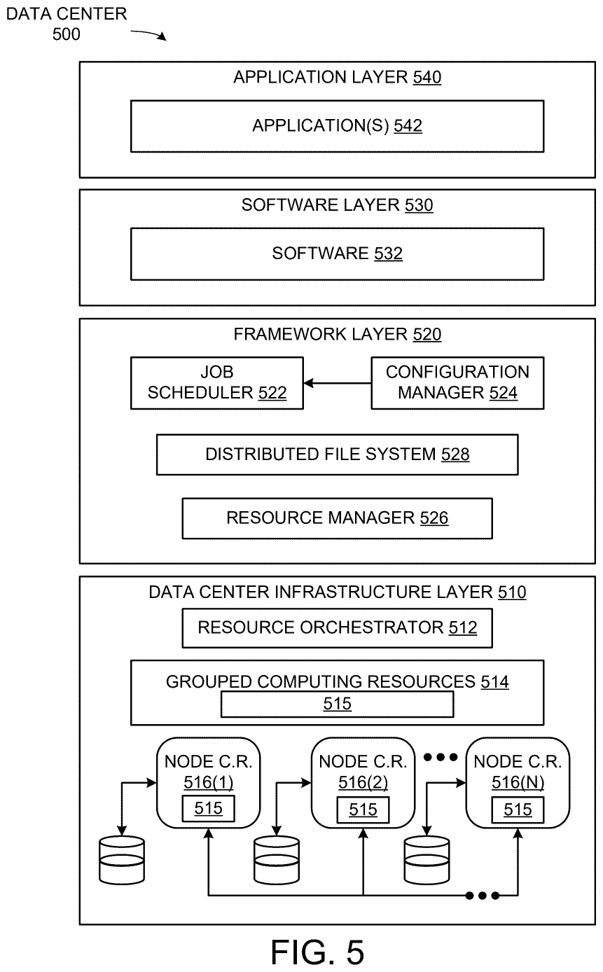

FIG. 5 illustrates the architecture of an example data center 500, in which at least one embodiment may be implemented. In at least one embodiment, data this center 500 includes a data center infrastructure layer 510, a framework layer 520, a software layer 530 and an application layer 540.

In at least one embodiment, as shown in FIG. 5, data center infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-816(N) may be a server having one or more of above-mentioned computing resources.

In at least one embodiment, grouped computing resources 514 may include separate groupings of node C.R.s housed within one or more racks (not shown), or many racks housed in data centers at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for data center 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of data center 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at data center infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a data center operator of data center 500 from making possibly bad configuration decisions and possibly avoiding underutilized and/or poor performing portions of a data center.

In at least one embodiment, data center 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 500. In at least one embodiment, trained machine learning models corresponding to one or more neural networks may be used to infer or predict information using resources described above with respect to data center 500 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein can provide for active noise cancelation for individual components in a data center, and can proactively adjust aspects of the noise cancelation based on predictions for well understood workflows.

### Computer Systems

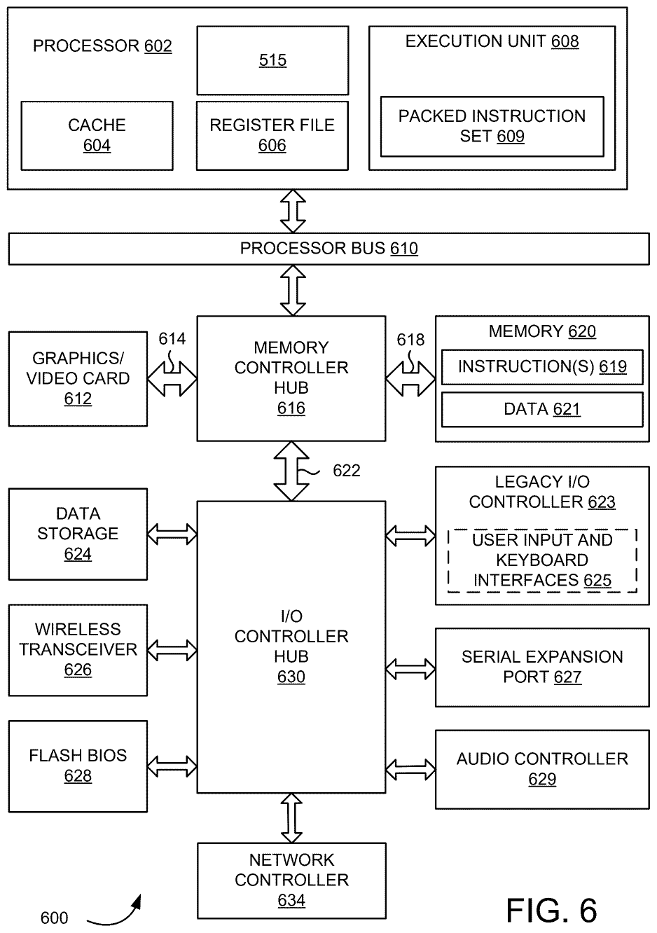

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high-speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 may illustrate an exemplary SoC In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein can provide for active noise cancelation for individual components in a data center, and can proactively adjust aspects of the noise cancelation based on predictions for well understood workflows.

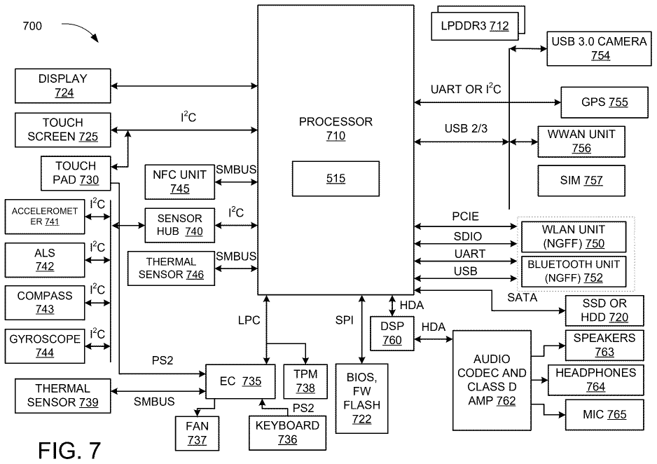

FIG. 7 is a block diagram illustrating an electronic device 700 for utilizing a processor 710, according to at least one embodiment. In at least one embodiment, electronic device 700 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 700 may include, without limitation, processor 710 communicatively coupled to any suitable number or kind of components, peripherals, modules, or devices. In at least one embodiment, processor 710 is coupled using a bus or interface, such as a I²C bus, a System Management Bus (“Sambas”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of FIG. 7 are interconnected using compute express link (CXL) interconnects.

In at least one embodiment, FIG. 7 may include a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (GPS) unit 755, a camera (“USB 3.0 camera”) 754 such as a USB 3.0 camera, and/or a Low Power Double Data Rate (“LPDDR”) memory unit (“LPDDR3”) 715 implemented in, for example, an LPDDR3 standard. These components may each be implemented in any suitable manner.

In at least one embodiment, other components may be communicatively coupled to processor 710 through components described herein. In at least one embodiment, an accelerometer 741, an ambient light sensor (“ALS”) 742, a compass 743, and a gyroscope 744 may be communicatively coupled to sensor hub 740. In at least one embodiment, a thermal sensor 739, a fan 737, a keyboard 736, and touch pad 730 may be communicatively coupled to EC 735. In at least one embodiment, speakers 763, headphones 764, and a microphone (“mic”) 765 may be communicatively coupled to an audio unit (“audio codec and class D amp”) 762, which may in turn be communicatively coupled to DSP 760. In at least one embodiment, audio unit 762 may include, for example and without limitation, an audio coder/decoder (“codec”) and a class D amplifier. In at least one embodiment, a SIM card (“SIM”) 757 may be communicatively coupled to WWAN unit 756. In at least one embodiment, components such as WLAN unit 750 and Bluetooth unit 752, as well as WWAN unit 756 may be implemented in a Next Generation Form Factor (“NGFF”).

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Embodiments presented herein can provide for active noise cancelation for individual components in a data center, and can proactively adjust aspects of the noise cancelation based on predictions for well understood workflows.

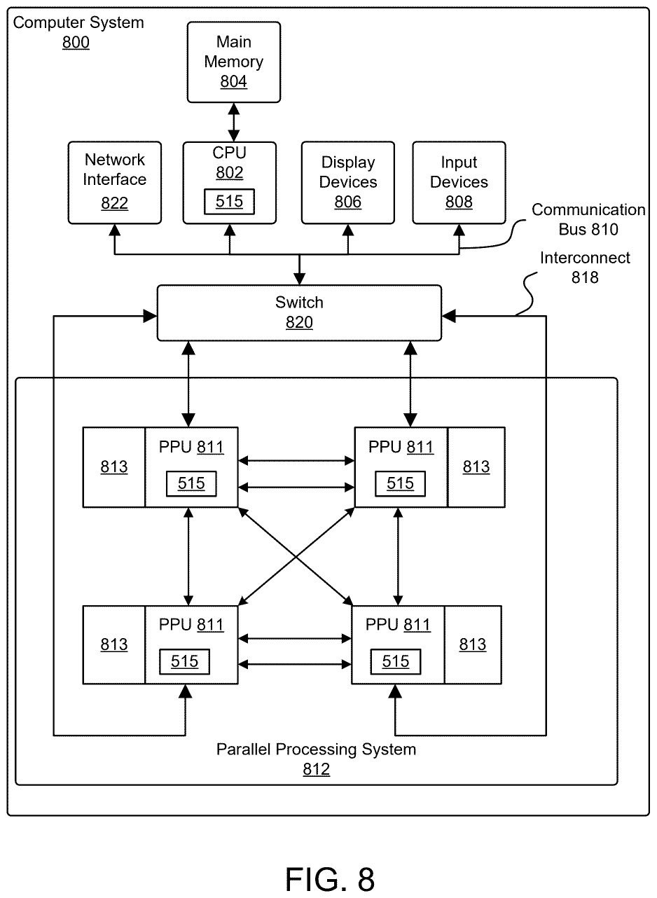

FIG. 8 illustrates a computer system 800, according to at least one embodiment. In at least one embodiment, computer system 800 is configured to implement various processes and methods described throughout this disclosure.

In at least one embodiment, computer system 800 comprises, without limitation, at least one central processing unit (“CPU”) 802 that is connected to a communication bus 810 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 800 includes, without limitation, a main memory 804 and control logic (e.g., implemented as hardware, software, or a combination thereof) and data are stored in main memory 804, which may take form of random access memory (“RAM”). In at least one embodiment, a network interface subsystem (“network interface”) 822 provides an interface to other computing devices and networks for receiving data from and transmitting data to other systems with computer system 800.

In at least one embodiment, computer system 800, in at least one embodiment, includes, without limitation, input devices 808, a parallel processing system 812, and display devices 806 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 808 such as keyboard, mouse, touchpad, microphone, etc. In at least one embodiment, each module described herein can be situated on a single semiconductor platform to form a processing system.

Inference and/or training logic 515 are used to perform inferencing and/or training operations associated with one or more embodiments. In at least one embodiment, inference and/or training logic 515 may be used in system FIG. 8 for inferencing or predicting operations based, at least in part, on weight parameters calculated using neural network training operations, neural network functions and/or architectures, or neural network use cases described herein.

Embodiments presented herein can provide for active noise cancelation for individual components in a data center, and can proactively adjust aspects of the noise cancelation based on predictions for well understood workflows.

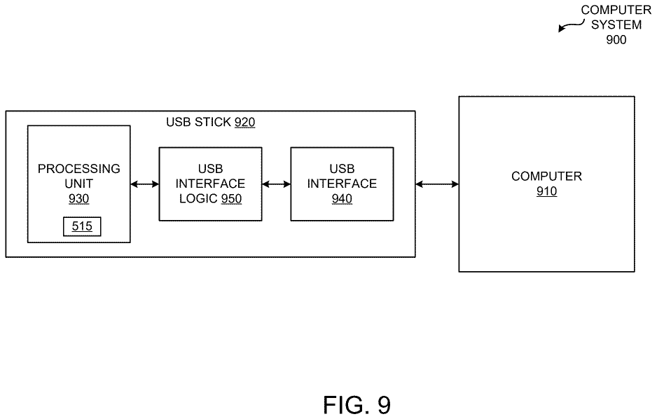

FIG. 9 illustrates a computer system 900, according to at least one embodiment. In at least one embodiment, computer system 900 includes, without limitation, a computer 910 and a USB stick 920. In at least one embodiment, computer 910 may include, without limitation, any number and type of processor(s) (not shown) and a memory (not shown). In at least one embodiment, computer 910 includes, without limitation, a server, a cloud instance, a laptop, and a desktop computer.

In at least one embodiment, USB stick 920 includes, without limitation, a processing unit 930, a USB interface 940, and USB interface logic 950. In at least one embodiment, processing unit 930 may be any instruction execution system, apparatus, or device capable of executing instructions. In at least one embodiment, processing unit 930 may include, without limitation, any number and type of processing cores (not shown). In at least one embodiment, processing unit 930 comprises an application specific integrated circuit (“ASIC”) that is optimized to perform any amount and type of operations associated with machine learning. For instance, in at least one embodiment, processing unit 930 is a tensor processing unit (“TPC”) that is optimized to perform machine learning inference operations. In at least one embodiment, processing unit 930 is a vision processing unit (“VPU”) that is optimized to perform machine vision and machine learning inference operations.

In at least one embodiment, USB interface 940 may be any type of USB connector or USB socket. For instance, in at least one embodiment, USB interface 940 is a USB 3.0 Type-C socket for data and power. In at least one embodiment, USB interface 940 is a USB 3.0 Type-A connector. In at least one embodiment, USB interface logic 950 may include any amount and type of logic that enables processing unit 930 to interface with devices (e.g., computer 910) via USB interface 940.

Inference and/or training logic 515 are used to perform inferencing and/or training operations associated with one or more embodiments. In at least one embodiment, inference and/or training logic 515 may be used in system FIG. 9 for inferencing or predicting operations based, at least in part, on weight parameters calculated using neural network training operations, neural network functions and/or architectures, or neural network use cases described herein.

Embodiments presented herein can provide for active noise cancelation for individual components in a data center, and can proactively adjust aspects of the noise cancelation based on predictions for well understood workflows.

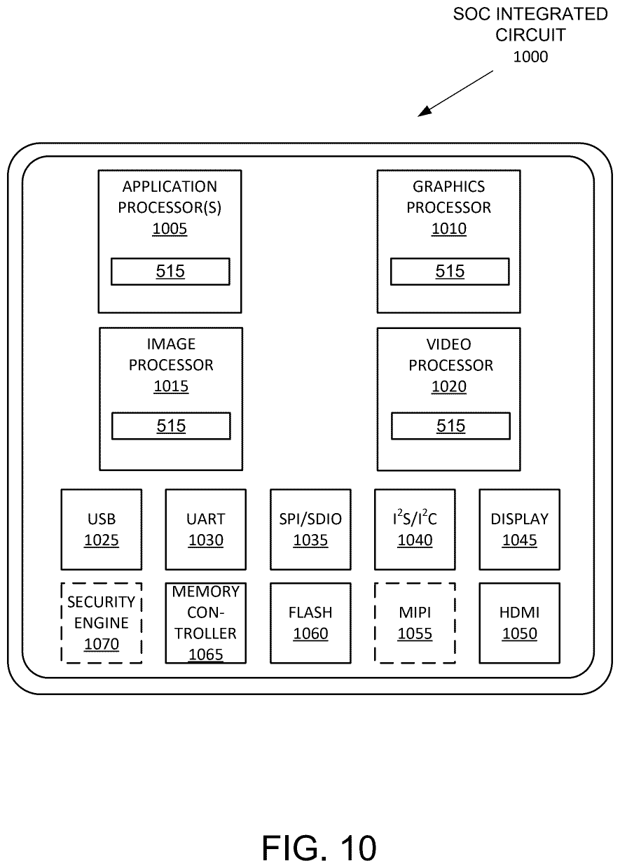

FIG. 10 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 10 is a block diagram illustrating an exemplary system-on-a-chip (SOC) integrated circuit 1000 that may be fabricated using one or more IP cores, according to at least one embodiment. In at least one embodiment, SOC integrated circuit 1000 includes one or more application processor(s) 1005 (e.g., CPUs), at least one graphics processor 1010, and may additionally include an image processor 1015 and/or a video processor 1020, any of which may be a modular IP core. In at least one embodiment, SOC integrated circuit 1000 includes peripheral or bus logic including a USB controller 1025, a UART controller 1030, an SPI/SDIO controller 1035, and an I²2S/I²2C controller 1040. In at least one embodiment, SOC integrated circuit 1000 can include a display device 1045 coupled to one or more of a high-definition multimedia interface (HDMI) controller 1050 and a mobile industry processor interface (MIPI) display interface 1055. In at least one embodiment, storage may be provided by a flash memory subsystem 1060 including flash memory and a flash memory controller. In at least one embodiment, a memory interface may be provided via a memory controller 1065 for access to SDRAM or SRAM memory devices. In at least one embodiment, some integrated circuits additionally include an embedded security engine 1070.

Inference and/or training logic 515 are used to perform inferencing and/or training operations associated with one or more embodiments. In at least one embodiment, inference and/or training logic 515 may be used in SOC integrated circuit 1000 for inferencing or predicting operations based, at least in part, on weight parameters calculated using neural network training operations, neural network functions and/or architectures, or neural network use cases described herein.

Embodiments presented herein can provide for active noise cancelation for individual components in a data center, and can proactively adjust aspects of the noise cancelation based on predictions for well understood workflows.

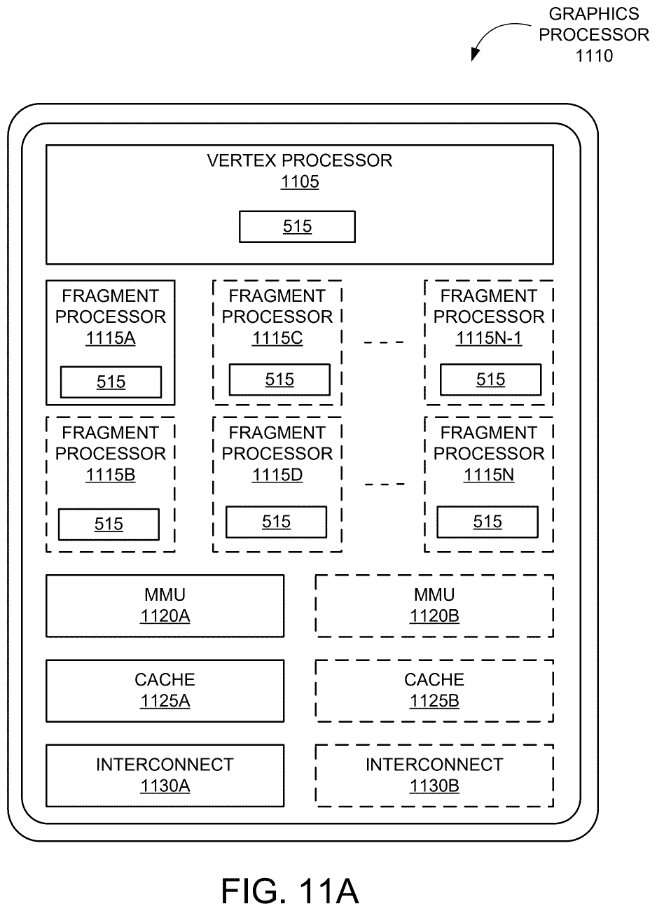

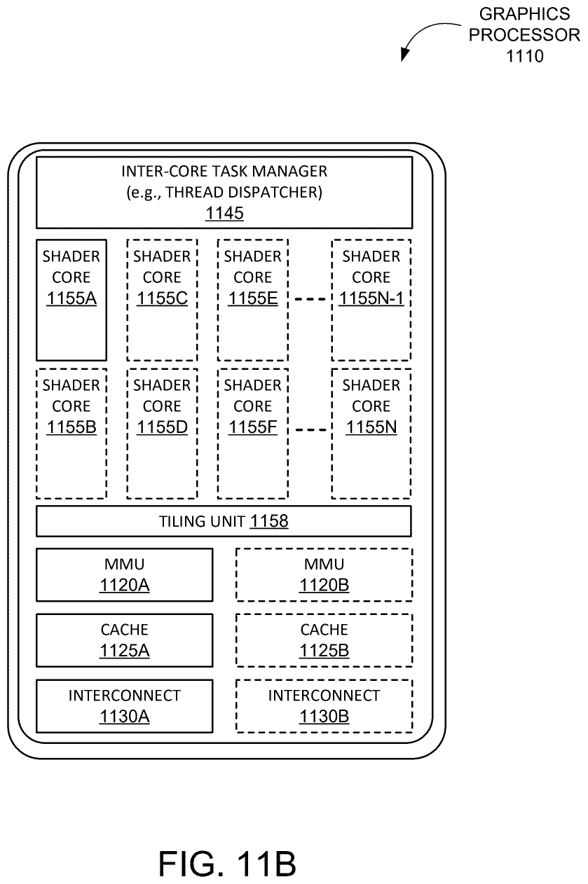

FIGS. 11A-11B illustrate exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIGS. 11A-11B are block diagrams illustrating exemplary graphics processors for use within an SoC, according to embodiments described herein. FIG. 11A illustrates an exemplary graphics processor 1110 of a system on a chip integrated circuit that may be fabricated using one or more IP cores, according to at least one embodiment. FIG. 11B illustrates an additional exemplary graphics processor 1140 of a system on a chip integrated circuit that may be fabricated using one or more IP cores, according to at least one embodiment. In at least one embodiment, graphics processor 1110 of FIG. 11A is a low power graphics processor core. In at least one embodiment, graphics processor 1140 of FIG. 11B is a higher performance graphics processor core. In at least one embodiment, each of graphics processors 1110, 1140 can be variants of computer system 900 of FIG. 9.

In at least one embodiment, graphics processor 1110 includes a vertex processor 1105 and one or more fragment processor(s) 1115A-1115N (e.g., 1115A, 1115B, 1115C, 1115D, through 1115N-1, and 1115N). In at least one embodiment, graphics processor 1110 can execute different shader programs via separate logic, such that vertex processor 1105 is optimized to execute operations for vertex shader programs, while one or more fragment processor(s) 1115A-1115N execute fragment (e.g., pixel) shading operations for fragment or pixel shader programs. In at least one embodiment, vertex processor 1105 performs a vertex processing stage of a 3D graphics pipeline and generates primitives and vertex data. In at least one embodiment, fragment processor(s) 1115A-1115N use primitive and vertex data generated by vertex processor 1105 to produce a framebuffer that is displayed on a display device. In at least one embodiment, fragment processor(s) 1115A-1115N are optimized to execute fragment shader programs as provided for in an OpenGL API, which may be used to perform similar operations as a pixel shader program as provided for in a Direct 3D API.

In at least one embodiment, graphics processor 1110 additionally includes one or more memory management units (MMUs) 1120A-1120B, cache(s) 1125A-1125B, and circuit interconnect(s) 1130A-1130B. In at least one embodiment, one or more MMU(s) 1120A-1120B provide for virtual to physical address mapping for graphics processor 1110, including for vertex processor 1105 and/or fragment processor(s) 1115A-1115N, which may reference vertex or image/texture data stored in memory, in addition to vertex or image/texture data stored in one or more cache(s) 1125A-1125B. In at least one embodiment, one or more MMU(s) 1120A-1120B may be synchronized with other MMUs within a system, including one or more MMUs associated with one or more vertex processor(s) 1105, image processors 1115, and/or video processors 1120 of FIG. 11A, such that each processor 1105-1120 can participate in a shared or unified virtual memory system. In at least one embodiment, one or more circuit interconnect(s) 1130A-1130B enable graphics processor 1110 to interface with other IP cores within SoC, either via an internal bus of SoC or via a direct connection.

In at least one embodiment, graphics processor 1140 includes one or more shader core(s) 1155A-1155N (e.g., 1155A, 1155B, 1155C, 1155D, 1155E, 1155F, through 1155N-1, and 1155N) as shown in FIG. 11B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1140 includes an inter-core task manager 1145, which acts as a thread dispatcher to dispatch execution threads to one or more shader cores 1155A-1155N and a tiling unit 1158 to accelerate tiling operations for tile-based rendering, in which rendering operations for a scene are subdivided in image space, for example to exploit local spatial coherence within a scene or to optimize use of internal caches.

Embodiments presented herein can provide for active noise cancelation for individual components in a data center, and can proactively adjust aspects of the noise cancelation based on predictions for well understood workflows.

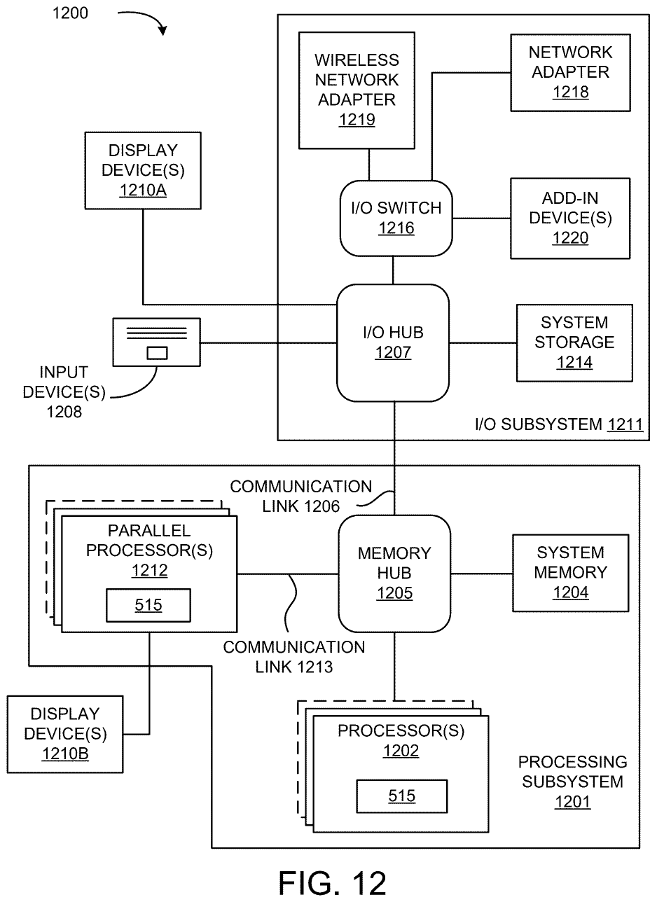

FIG. 12 is a block diagram illustrating a computing system 1200 according to at least one embodiment. In at least one embodiment, computing system 1200 includes a processing subsystem 1201 having one or more processor(s) 1202 and a system memory 1204 communicating via an interconnection path that may include a memory hub 1205. In at least one embodiment, memory hub 1205 may be a separate component within a chipset component or may be integrated within one or more processor(s) 1202. In at least one embodiment, memory hub 1205 couples with an I/O subsystem 1211 via a communication link 1206. In at least one embodiment, I/O subsystem 1211 includes an I/O hub 1207 that can enable computing system 1200 to receive input from one or more input device(s) 1208. In at least one embodiment, I/O hub 1207 can enable a display controller, which may be included in one or more processor(s) 1202, to provide outputs to one or more display device(s) 1210A. In at least one embodiment, one or more display device(s) 1210A coupled with I/O hub 1207 can include a local, internal, or embedded display device.

In at least one embodiment, processing subsystem 1201 includes one or more parallel processor(s) 1212 coupled to memory hub 1205 via a bus or other communication link 1213. In at least one embodiment, communication link 1213 may use one of any number of standards based communication link technologies or protocols, such as but not limited to PCI Express, or may be a vendor-specific communications interface or communications fabric. In at least one embodiment, one or more parallel processor(s) 1212 form a computationally focused parallel or vector processing system that can include a large number of processing cores and/or processing clusters, such as a many-integrated core (MIC) processor. In at least one embodiment, some or all of parallel processor(s) 1212 form a graphics processing subsystem that can output pixels to one of one or more display device(s) 1210A coupled via I/O hub 1207. In at least one embodiment, parallel processor(s) 1212 can also include a display controller and display interface (not shown) to enable a direct connection to one or more display device(s) 1210B. In at least one embodiment, parallel processor(s) 1212 include one or more cores, such as computing system 1200 discussed herein.

In at least one embodiment, a system storage unit 1214 can connect to I/O hub 1207 to provide a storage mechanism for computing system 1200. In at least one embodiment, an I/O switch 1216 can be used to provide an interface mechanism to enable connections between I/O hub 1207 and other components, such as a network adapter 1218 and/or a wireless network adapter 1219 that may be integrated into platform, and various other devices that can be added via one or more add-in device(s) 1220. In at least one embodiment, network adapter 1218 can be an Ethernet adapter or another wired network adapter. In at least one embodiment, wireless network adapter 1219 can include one or more of a Wi-Fi, Bluetooth, near field communication (NFC), or other network device that includes one or more wireless radios.

In at least one embodiment, computing system 1200 can include other components not explicitly shown, including USB or other port connections, optical storage drives, video capture devices, and like, may also be connected to I/O hub 1207. In at least one embodiment, communication paths interconnecting various components in FIG. 12 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1212 incorporate circuitry optimized for graphics and video processing, including, for example, video output circuitry, and constitutes a graphics processing unit (GPU), e.g., parallel processor(s) 1212 includes graphics core 1200. In at least one embodiment, parallel processor(s) 1212 incorporate circuitry optimized for general purpose processing. In at least embodiment, components of computing system 1200 may be integrated with one or more other system elements on a single integrated circuit. For example, in at least one embodiment, parallel processor(s) 1212, memory hub 1205, processor(s) 1202, and I/O hub 1207 can be integrated into a system on chip (SoC) integrated circuit. In at least one embodiment, components of computing system 1200 can be integrated into a single package to form a system in package (SIP) configuration. In at least one embodiment, at least a portion of components of computing system 1200 can be integrated into a multi-chip module (MCM), which can be interconnected with other multi-chip modules into a modular computing system.

Inference and/or training logic 515 are used to perform inferencing and/or training operations associated with one or more embodiments. In at least one embodiment, inference and/or training logic 515 may be used in system FIG. 12 for inferencing or predicting operations based, at least in part, on weight parameters calculated using neural network training operations, neural network functions and/or architectures, or neural network use cases described herein.

Embodiments presented herein can provide for active noise cancelation for individual components in a data center, and can proactively adjust aspects of the noise cancelation based on predictions for well understood workflows.

### Processors

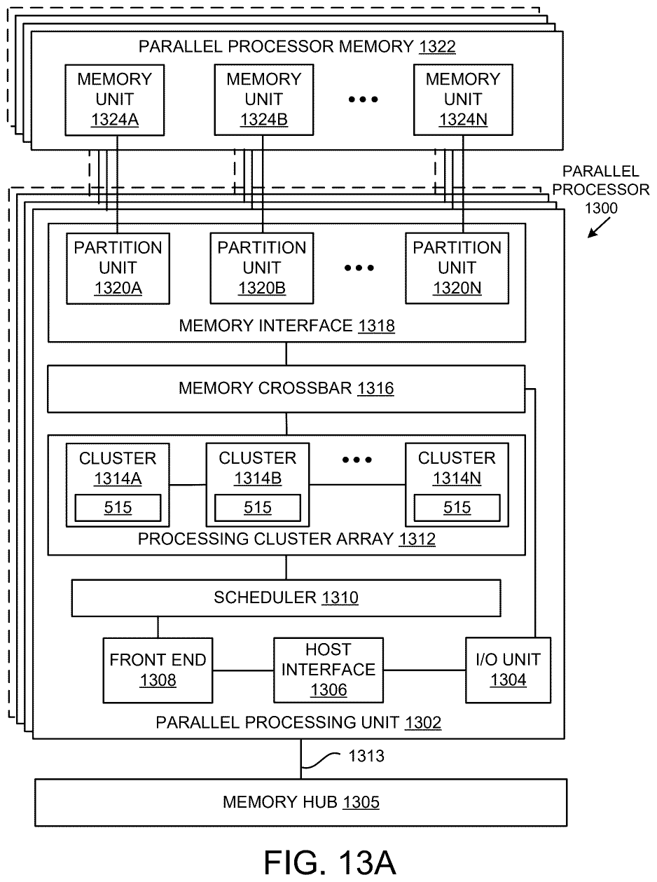

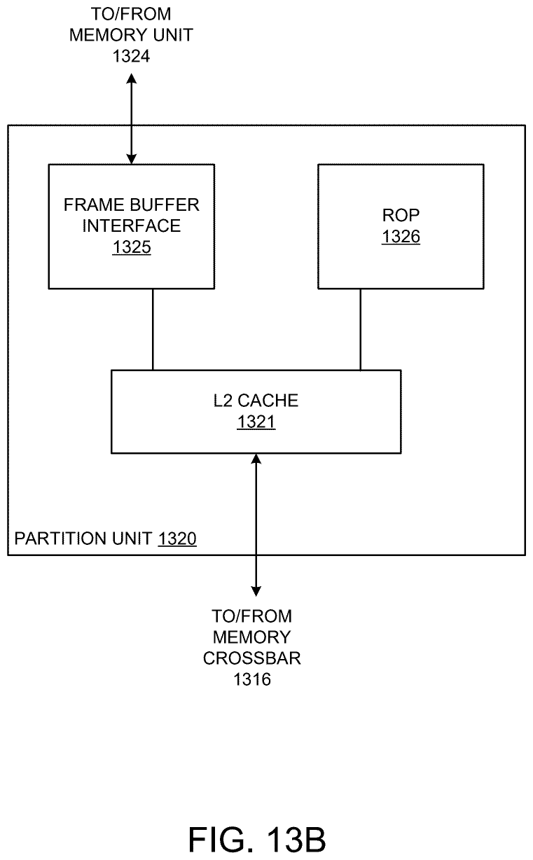

FIG. 13A illustrates a parallel processor 1300 according to at least one embodiment. In at least one embodiment, various components of parallel processor 1300 may be implemented using one or more integrated circuit devices, such as programmable processors, application specific integrated circuits (ASICs), or field programmable gate arrays (FPGA). In at least one embodiment, illustrated parallel processor 1300 is a variant of one or more parallel processor(s) 1212 shown in FIG. 12 according to an exemplary embodiment. In at least one embodiment, a parallel processor 1300 includes one or more graphics cores 1200.

In at least one embodiment, parallel processor 1300 includes a parallel processing unit 1302. In at least one embodiment, parallel processing unit 1302 includes an I/O unit 1304 that enables communication with other devices, including other instances of parallel processing unit 1302. In at least one embodiment, I/O unit 1304 may be directly connected to other devices. In at least one embodiment, I/O unit 1304 connects with other devices via use of a hub or switch interface, such as a memory hub 1305. In at least one embodiment, connections between memory hub 1305 and I/O unit 1304 form a communication link 1313. In at least one embodiment, I/O unit 1304 connects with a host interface 1306 and a memory crossbar 1316, where host interface 1306 receives commands directed to performing processing operations and memory crossbar 1316 receives commands directed to performing memory operations.

In at least one embodiment, when host interface 1306 receives a command buffer via I/O unit 1304, host interface 1306 can direct work operations to perform those commands to a front end 1308. In at least one embodiment, front end 1308 couples with a scheduler 1310 (which may be referred to as a sequencer), which is configured to distribute commands or other work items to a processing cluster array 1312. In at least one embodiment, scheduler 1310 ensures that processing cluster array 1312 is properly configured and in a valid state before tasks are distributed to a cluster of processing cluster array 1312. In at least one embodiment, scheduler 1310 is implemented via firmware logic executing on a microcontroller. In at least one embodiment, microcontroller implemented scheduler 1310 is configurable to perform complex scheduling and work distribution operations at coarse and fine granularity, enabling rapid preemption and context switching of threads executing on processing array 1312. In at least one embodiment, host software can prove workloads for scheduling on processing cluster array 1312 via one of multiple graphics processing paths. In at least one embodiment, workloads can then be automatically distributed across processing array cluster 1312 by scheduler 1310 logic within a microcontroller including scheduler 1310.

In at least one embodiment, processing cluster array 1312 can include up to “N” processing clusters (e.g., cluster 1314A, cluster 1314B, through cluster 1314N), where “N” represents a positive integer (which may be a different integer “N” than used in other figures). In at least one embodiment, each cluster 1314A-1314N of processing cluster array 1312 can execute a large number of concurrent threads. In at least one embodiment, scheduler 1310 can allocate work to clusters 1314A-1314N of processing cluster array 1312 using various scheduling and/or work distribution algorithms, which may vary depending on workload arising for each type of program or computation. In at least one embodiment, scheduling can be handled dynamically by scheduler 1310, or can be assisted in part by compiler logic during compilation of program logic configured for execution by processing cluster array 1312. In at least one embodiment, different clusters 1314A-1314N of processing cluster array 1312 can be allocated for processing different types of programs or for performing different types of computations.

In at least one embodiment, processing cluster array 1312 can be configured to perform various types of parallel processing operations. In at least one embodiment, processing cluster array 1312 is configured to perform general-purpose parallel compute operations. For example, in at least one embodiment, processing cluster array 1312 can include logic to execute processing tasks including filtering of video and/or audio data, performing modeling operations, including physics operations, and performing data transformations.

In at least one embodiment, processing cluster array 1312 is configured to perform parallel graphics processing operations. In at least one embodiment, processing cluster array 1312 can include additional logic to support execution of such graphics processing operations, including but not limited to, texture sampling logic to perform texture operations, as well as tessellation logic and other vertex processing logic. In at least one embodiment, processing cluster array 1312 can be configured to execute graphics processing related shader programs such as but not limited to, vertex shaders, tessellation shaders, geometry shaders, and pixel shaders. In at least one embodiment, parallel processing unit 1302 can transfer data from system memory via I/O unit 1304 for processing. In at least one embodiment, during processing, transferred data can be stored to on-chip memory (e.g., parallel processor memory 1322) during processing, then written back to system memory.

In at least one embodiment, when parallel processing unit 1302 is used to perform graphics processing, scheduler 1310 can be configured to divide a processing workload into approximately equal sized tasks, to better enable distribution of graphics processing operations to multiple clusters 1314A-1314N of processing cluster array 1312. In at least one embodiment, portions of processing cluster array 1312 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1314A-1314N may be stored in buffers to allow intermediate data to be transmitted between clusters 1314A-1314N for further processing.

In at least one embodiment, processing cluster array 1312 can receive processing tasks to be executed via scheduler 1310, which receives commands defining processing tasks from front end 1308. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1310 may be configured to fetch indices corresponding to tasks or may receive indices from front end 1308. In at least one embodiment, front end 1308 can be configured to ensure processing cluster array 1312 is configured to a valid state before a workload specified by incoming command buffers (e.g., batch-buffers, push buffers, etc.) is initiated.

In at least one embodiment, each of one or more instances of parallel processing unit 1302 can couple with a parallel processor memory 1322. In at least one embodiment, parallel processor memory 1322 can be accessed via memory crossbar 1316, which can receive memory requests from processing cluster array 1312 as well as I/O unit 1304. In at least one embodiment, memory crossbar 1316 can access parallel processor memory 1322 via a memory interface 1318. In at least one embodiment, memory interface 1318 can include multiple partition units (e.g., partition unit 1320A, partition unit 1320B, through partition unit 1320N) that can each couple to a portion (e.g., memory unit) of parallel processor memory 1322. In at least one embodiment, a number of partition units 1320A-1320N is configured to be equal to a number of memory units, such that a first partition unit 1320A has a corresponding first memory unit 1324A, a second partition unit 1320B has a corresponding memory unit 1324B, and an N-th partition unit 1320N has a corresponding N-th memory unit 1324N. In at least one embodiment, a number of partition units 1320A-1320N may not be equal to a number of memory units.

In at least one embodiment, memory units 1324A-1324N can include various types of memory devices, including dynamic random access memory (DRAM) or graphics random access memory, such as synchronous graphics random access memory (SGRAM), including graphics double data rate (GDDR) memory. In at least one embodiment, memory units 1324A-1324N may also include 3D stacked memory, including but not limited to high bandwidth memory (HBM), HBM2e, or HDM3. In at least one embodiment, render targets, such as frame buffers or texture maps may be stored across memory units 1324A-1324N, allowing partition units 1320A-1320N to write portions of each render target in parallel to efficiently use available bandwidth of parallel processor memory 1322. In at least one embodiment, a local instance of parallel processor memory 1322 may be excluded in favor of a unified memory design that utilizes system memory in conjunction with local cache memory.

In at least one embodiment, any one of clusters 1314A-1314N of processing cluster array 1312 can process data that will be written to any of memory units 1324A-1324N within parallel processor memory 1322. In at least one embodiment, memory crossbar 1316 can be configured to transfer an output of each cluster 1314A-1314N to any partition unit 1320A-1320N or to another cluster 1314A-1314N, which can perform additional processing operations on an output. In at least one embodiment, each cluster 1314A-1314N can communicate with memory interface 1318 through memory crossbar 1316 to read from or write to various external memory devices. In at least one embodiment, memory crossbar 1316 has a connection to memory interface 1318 to communicate with I/O unit 1304, as well as a connection to a local instance of parallel processor memory 1322, enabling processing units within different processing clusters 1314A-1314N to communicate with system memory or other memory that is not local to parallel processing unit 1302. In at least one embodiment, memory crossbar 1316 can use virtual channels to separate traffic streams between clusters 1314A-1314N and partition units 1320A-1320N.

In at least one embodiment, multiple instances of parallel processing unit 1302 can be provided on a single add-in card, or multiple add-in cards can be interconnected. In at least one embodiment, different instances of parallel processing unit 1302 can be configured to interoperate even if different instances have different numbers of processing cores, different amounts of local parallel processor memory, and/or other configuration differences. For example, in at least one embodiment, some instances of parallel processing unit 1302 can include higher precision floating point units relative to other instances. In at least one embodiment, systems incorporating one or more instances of parallel processing unit 1302 or parallel processor 1300 can be implemented in a variety of configurations and form factors, including but not limited to desktop, laptop, or handheld personal computers, servers, workstations, game consoles, and/or embedded systems.

FIG. 13B is a block diagram of a partition unit 1320 according to at least one embodiment. In at least one embodiment, partition unit 1320 is an instance of one of partition units 1320A-1320N of FIG. 13A. In at least one embodiment, partition unit 1320 includes an L2 cache 1321, a frame buffer interface 1325, and a ROP 1326 (raster operations unit). In at least one embodiment, L2 cache 1321 is a read/write cache that is configured to perform load and store operations received from memory crossbar 1316 and ROP 1326. In at least one embodiment, read misses and urgent write-back requests are output by L2 cache 1321 to frame buffer interface 1325 for processing. In at least one embodiment, updates can also be sent to a frame buffer via frame buffer interface 1325 for processing. In at least one embodiment, frame buffer interface 1325 interfaces with one of memory units in parallel processor memory, such as memory units 1324A-1324N of FIG. 13A (e.g., within parallel processor memory 1322).

In at least one embodiment, ROP 1326 is a processing unit that performs raster operations such as stencil, z test, blending, etc. In at least one embodiment, ROP 1326 then outputs processed graphics data that is stored in graphics memory. In at least one embodiment, ROP 1326 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1326 can vary based on statistical characteristics of data to be compressed. For example, in at least one embodiment, delta color compression is performed on depth and color data on a per-tile basis.

In at least one embodiment, ROP 1326 is included within each processing cluster (e.g., cluster 1314A-1314N of FIG. 13A) instead of within partition unit 1320. In at least one embodiment, read and write requests for pixel data are transmitted over memory crossbar 1316 instead of pixel fragment data. In at least one embodiment, processed graphics data may be displayed on a display device, such as one of one or more display device(s) 1510 of FIG. 15, routed for further processing by processing unit(s) 1302, or routed for further processing by one of processing entities within parallel processor 1300 of FIG. 13A.

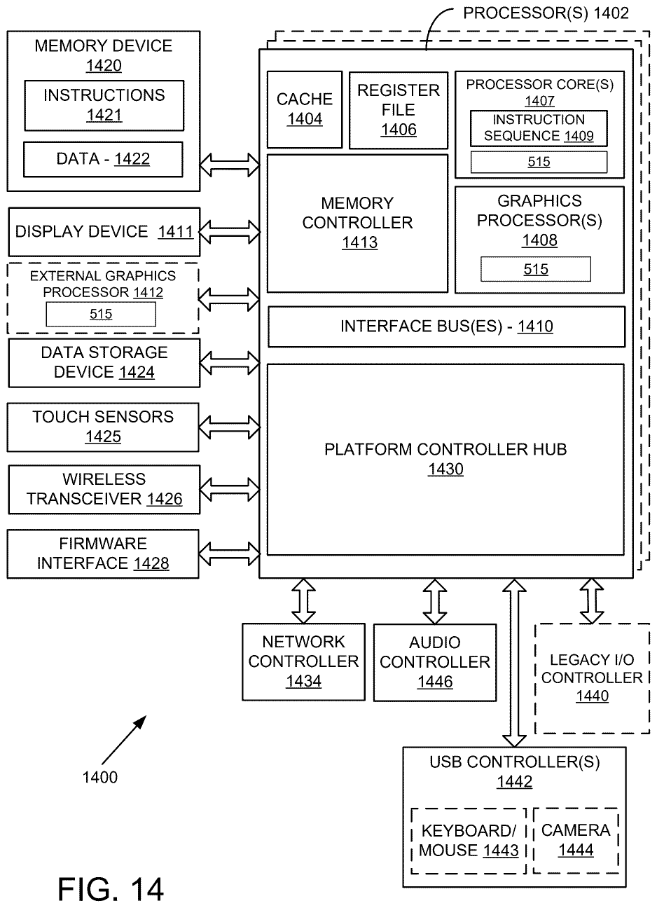

FIG. 14 is a block diagram of a processing system, according to at least one embodiment. In at least one embodiment, system 1400 includes one or more processor(s) 1402 and one or more graphics processor(s) 1408, and may be a single processor desktop system, a multiprocessor workstation system, or a server system having a large number of processor(s) 1402 or processor core(s) 1407. In at least one embodiment, system 1400 is a processing platform incorporated within a system-on-a-chip (SoC) integrated circuit for use in mobile, handheld, or embedded devices. In at least one embodiment, one or more graphics processor(s) 1408 include one or more graphics cores 1200.

In at least one embodiment, system 1400 can include, or be incorporated within a server-based gaming platform, a game console, including a game and media console, a mobile gaming console, a handheld game console, or an online game console. In at least one embodiment, system 1400 is a mobile phone, a smart phone, a tablet computing device or a mobile Internet device. In at least one embodiment, processing system 1400 can also include, couple with, or be integrated within a wearable device, such as a smart watch wearable device, a smart eyewear device, an augmented reality device, or a virtual reality device. In at least one embodiment, processing system 1400 is a television or set top box device having one or more processor(s) 1402 and a graphical interface generated by one or more graphics processor(s) 1408.

In at least one embodiment, one or more processor(s) 1402 each include one or more processor core(s) 1407 to process instructions which, when executed, perform operations for system and user software. In at least one embodiment, each of one or more processor core(s) 1407 is configured to process a specific instruction sequence 1409. In at least one embodiment, instruction sequence 1409 may facilitate Complex Instruction Set Computing (CISC), Reduced Instruction Set Computing (RISC), or computing via a Very Long Instruction Word (VLIW). In at least one embodiment, processor core(s) 1407 may each process a different instruction sequence 1409, which may include instructions to facilitate emulation of other instruction sequences. In at least one embodiment, processor core(s) 1407 may also include other processing devices, such a Digital Signal Processor (DSP).

In at least one embodiment, processor(s) 1402 includes a cache memory 1404. In at least one embodiment, processor(s) 1402 can have a single internal cache or multiple levels of internal cache. In at least one embodiment, cache memory is shared among various components of processor(s) 1402. In at least one embodiment, processor(s) 1402 also uses an external cache (e.g., a Level-3 (L3) cache or Last Level Cache (LLC)) (not shown), which may be shared among processor core(s) 1407 using known cache coherency techniques. In at least one embodiment, a register file 1406 is additionally included in processor(s) 1402, which may include different types of registers for storing different types of data (e.g., integer registers, floating point registers, status registers, and an instruction pointer register). In at least one embodiment, register file 1406 may include general-purpose registers or other registers.

In at least one embodiment, one or more processor(s) 1402 are coupled with one or more interface bus(es) 1410 to transmit communication signals such as address, data, or control signals between processor(s) 1402 and other components in system 1400. In at least one embodiment, interface bus(es) 1410 can be a processor bus, such as a version of a Direct Media Interface (DMI) bus. In at least one embodiment, interface bus(es) 1410 is not limited to a DMI bus, and may include one or more Peripheral Component Interconnect buses (e.g., PCI, PCI Express), memory busses, or other types of interface busses. In at least one embodiment processor(s) 1402 include an integrated memory controller 1416 and a platform controller hub 1430. In at least one embodiment, memory controller 1416 facilitates communication between a memory device and other components of system 1400, while platform controller hub (PCH) 1430 provides connections to I/O devices via a local I/O bus.

In at least one embodiment, a memory device 1420 can be a dynamic random access memory (DRAM) device, a static random access memory (SRAM) device, flash memory device, phase-change memory device, or some other memory device having suitable performance to serve as process memory. In at least one embodiment, memory device 1420 can operate as system memory for system 1400, to store data 1422 and instructions 1421 for use when one or more processor(s) 1402 executes an application or process. In at least one embodiment, memory controller 1416 also couples with an optional external graphics processor 1412, which may communicate with one or more graphics processor(s) 1408 in processor(s) 1402 to perform graphics and media operations. In at least one embodiment, a display device 1411 can connect to processor(s) 1402. In at least one embodiment, display device 1411 can include one or more of an internal display device, as in a mobile electronic device or a laptop device, or an external display device attached via a display interface (e.g., DisplayPort, etc.). In at least one embodiment, display device 1411 can include a head mounted display (HMD) such as a stereoscopic display device for use in virtual reality (VR) applications or augmented reality (AR) applications.

In at least one embodiment, platform controller hub 1430 enables peripherals to connect to memory device 1420 and processor(s) 1402 via a high-speed I/O bus. In at least one embodiment, I/O peripherals include, but are not limited to, an audio controller 1446, a network controller 1434, a firmware interface 1428, a wireless transceiver 1426, touch sensors 1425, a data storage device 1424 (e.g., hard disk drive, flash memory, etc.). In at least one embodiment, data storage device 1424 can connect via a storage interface (e.g., SATA) or via a peripheral bus, such as a Peripheral Component Interconnect bus (e.g., PCI, PCI Express). In at least one embodiment, touch sensors 1425 can include touch screen sensors, pressure sensors, or fingerprint sensors. In at least one embodiment, wireless transceiver 1426 can be a Wi-Fi transceiver, a Bluetooth transceiver, or a mobile network transceiver such as a 3G, 4G, or Long Term Evolution (LTE) transceiver. In at least one embodiment, firmware interface 1428 enables communication with system firmware, and can be, for example, a unified extensible firmware interface (UEFI). In at least one embodiment, network controller 1434 can enable a network connection to a wired network. In at least one embodiment, a high-performance network controller (not shown) couples with interface bus(es) 1410. In at least one embodiment, audio controller 1446 is a multi-channel high definition audio controller. In at least one embodiment, system 1400 includes an optional legacy I/O controller 1440 for coupling legacy (e.g., Personal System 2 (PS/2)) devices to system 1400. In at least one embodiment, platform controller hub 1430 can also connect to one or more Universal Serial Bus (USB) controller(s) 1442 connect input devices, such as keyboard and mouse 1443 combinations, a camera 1444, or other USB input devices.

In at least one embodiment, an instance of memory controller 1416 and platform controller hub 1430 may be integrated into a discreet external graphics processor, such as external graphics processor 1412. In at least one embodiment, platform controller hub 1430 and/or memory controller 1416 may be external to one or more processor(s) 1402. For example, in at least one embodiment, system 1400 can include an external memory controller 1416 and platform controller hub 1430, which may be configured as a memory controller hub and peripheral controller hub within a system chipset that is in communication with processor(s) 1402.

Embodiments presented herein can provide for active noise cancelation for individual components in a data center, and can proactively adjust aspects of the noise cancelation based on predictions for well understood workflows.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A noise canceling casing for a graphics processing unit (GPU), comprising:
an enclosure having an interior formed to surround the GPU;
a fan positioned in the interior to direct heated air away from the GPU during operation;
an outlet pipe positioned proximate an opening in the enclosure to receive a flow of the heated air and direct the heated air in a determined direction;
a microphone positioned in the outlet pipe to capture noise generated by at least the fan in the enclosure;
a speaker positioned in the outlet pipe; and
processing circuitry to receive audio from the microphone, representative of the captured noise, and generate inverse audio having an inverted phase to the received audio, the processing circuitry further to cause the speaker to play the inverse audio to destructively interfere with the noise generated by at least the fan in the enclosure to reduce end amount of noise emitted from the outlet pipe.

2. The noise canceling casing of claim 1, wherein the microphone, the speaker, and the processing circuitry are activated at least partially in response to an anticipated load on the GPU at least satisfying a noise cancelation threshold.

3. The noise canceling casing of claim 1, wherein the microphone, the speaker, and the processing circuitry are deactivated at least partially in response to an anticipated load on the GPU falling below the noise cancelation threshold or a separate deactivation threshold.

4. The noise canceling casing of claim 1, wherein the enclosure is formed of a noise-insulating material.

5. The noise canceling casing of claim 1, wherein the outlet pipe is shaped to direct the flow of the heated air toward a back side of the noise canceling casing.

6. The noise canceling casing of claim 4, wherein the outlet pipe is shaped to fit between the noise canceling casing and another noise canceling casing of an adjacent GPU in a rack.

7. The noise canceling casing of claim 1, wherein the microphone is selected to only capture audio over a low-frequency band associated with the noise generated by the fan in the enclosure.

8. The noise canceling casing of claim 1, wherein the microphone is positioned proximate the fan in the outlet pipe, and wherein the speaker is positioned proximate an outlet of the outlet pipe.

9. The noise canceling casing of claim 1, wherein the processing circuitry is located on a system-on-chip (SoC) including at least the speaker in the outlet pipe.

10. A system, comprising:
a housing to enclose at least one heat-generating component and at least one noise-generating component;
a microphone to capture audio generated in the housing by at least one noise-generating component;
a speaker to playback inverse audio to cancel the audio generated by the at least one noise-generating component; and
one or more processing units to activate the microphone and the speaker in response to an anticipated load on the at least one heat-generating component, the one or more processing units further to generate the inverse audio by inverting a phase of the captured audio and providing the inverse audio to the speaker to provide controlled playback of the inverse audio to cancel out at least a portion of the noise generated in the housing.

11. The system of claim 10, wherein the at least one heat-generating component includes at least a processor, a server, or a network switch.

12. The system of claim 10, wherein the at least one noise-generating component includes at least an inductor, a capacitor, a coolant pump, or a fan to direct heated air away from the at least one heat-generating component.

13. The system of claim 10, wherein the microphone, the speaker, and the one or more processing units are activated at least partially in response to an anticipated load on the at least one heat-generating component at least satisfying a noise cancelation threshold.

14. The system of claim 10, wherein the microphone, the speaker, and the one or more processing units are deactivated at least partially in response to an anticipated load on the at least one heat-generating component no longer satisfying a noise cancelation threshold or a separate deactivation threshold.

15. The system of claim 10, wherein the system is at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

16. A method, comprising:
anticipating that a future load on a processing unit will at least satisfy a noise cancelation criterion within an upcoming period of time;
activating a microphone positioned to capture noise generated by a noise-generating component associated with the processing unit;
generating inverse audio that has an inverted phase with respect to the captured noise generated by the noise-generating component; and
providing, using a speaker associated with the microphone, playback of the inverse audio to destructively interfere with the noise generated by the noise-generating component and reduce a volume of the generated noise.

17. The method of claim 16, further comprising:
anticipating that a second future load on the processing unit will fall below the noise cancelation criterion; and
deactivating, after a cool down period, at least the microphone and the speaker.

18. The method of claim 16, where the microphone and the speaker are positioned in a sound-proof outlet tube for directing the noise away from the processing unit.

19. The method of claim 18, wherein the processing unit is located in a sound-proof housing including an opening for allowing heat and sound to pass from the sound-proof housing, the sound-proof outlet tube positioned to receive the heat and sound passing from the opening.

20. The method of claim 18, wherein the noise-generating component is a fan positioned to direct heat away from the processing unit through the sound-proof outlet tube.
